(19) United States
(12) Patent Application Publication
(10) Pub. No.: US 2018/0213024 A1
(43) Pub. Date: Jul. 26, 2018

(54) INFORMATION TRANSMISSION DEVICE, METHOD AND NON-TRANSITORY COMPUTER-READABLE STORAGE MEDIUM

(71) Applicant: FUJITSU LIMITED, Kawasaki-shi (JP)

(72) Inventors: Mitsuru Tanaka, Saitama (JP); HANIYA SUZUKI, Matsudo (JP)

(73) Assignee: FUJITSU LIMITED, Kawasaki-shi (JP)

(21) Appl. No.: 15/861,351

(22) Filed: Jan. 3, 2018

(30) Foreign Application Priority Data
Jan. 24, 2017 (JP) 2017-010537

(51) Int. Cl. H04L 29/08; H04N 21/462

(52) U.S. Cl. CPC H04L 67/06; H04L 67/325; H04N 21/4622; H04L 67/26; H04L 67/02

(57) ABSTRACT

An information transmission device configured to be coupled to a plurality of information receiving devices, each of which includes a storage area and executes a first processing of restricting disclosure of data held in the storage area, the information transmission device includes a memory, and a processor coupled to the memory and configured to transmit first data to each of the plurality of information receiving devices, and transmit, after transmitting the first data to each of the plurality of information receiving devices, a release instruction signal that instructs a second processing of releasing the first processing for the first data held in the storage area to each of the plurality of information receiving devices simultaneously.

### CROSS-REFERENCE TO RELATED APPLICATION

This application is based upon and claims the benefit of priority of the prior Japanese Patent Application No. 2017-10537, filed on Jan. 24, 2017, the entire contents of which are incorporated herein by reference.

### FIELD

The embodiments discussed herein are related to an information transmission device, a method and a non-transitory computer-readable storage medium.

### BACKGROUND

A distribution server that distributes information simultaneously to a plurality of reception servers is known. The distribution server performs simultaneous distribution of information by transmitting, when a distribution time arrives, for example, a file that stores information to each reception server. As such distribution of information, for example, it has been proposed to distribute a program that is designated by time table data, for example, by temporally synchronizing a control server and a user terminal. Also, for example, it has been proposed to calculate, before a scheduled viewing start time, a scheduled contents distribution start time and a scheduled distribution end time and distribute contents in advance.

Also, for example, it has been proposed that a transmission side device does not directly distribute information but sends access information including an access destination device that stores information that is desired to be sent and a scheduled distribution start time and a reception side device performs an access for data acquisition in accordance with a distribution start time based on the access information. Moreover, for example, it has been proposed that, when a client couples to a distribution server to receive distribution information, the distribution server dynamically changes a coupling destination of the client in accordance with an operation state of the distribution server. Examples of the related art include International Publication Pamphlet No. WO02/037855, Japanese Laid-open Patent Publication No. 2008-252735, Japanese Laid-open Patent Publication No. 2010-193256, and Japanese Laid-open Patent Publication No. 2010-072894.

### SUMMARY

According to an aspect of the invention, an information transmission device configured to be coupled to a plurality of information receiving devices, each of which includes a storage area and executes a first processing of restricting disclosure of data held in the storage area, the information transmission device includes a memory, and a processor coupled to the memory and configured to transmit first data to each of the plurality of information receiving devices, and transmit, after transmitting the first data to each of the plurality of information receiving devices, a release instruction signal that instructs a second processing of releasing the first processing for the first data held in the storage area to each of the plurality of information receiving devices simultaneously.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a distribution control system of an embodiment;

FIG. 2 is a block diagram illustrating an example of a configuration of a distribution server of an embodiment;

FIG. 3 is a block diagram illustrating an example of a configuration of a reception server of an embodiment;

FIG. 4 is a diagram illustrating an example of a disclosure folder;

FIG. 5 is a sequence diagram illustrating an example of distribution control processing of an embodiment;

FIG. 6 is a sequence diagram illustrating the example of distribution control processing of the embodiment; and

FIG. 7 is a diagram illustrating an example of a computer that executes a distribution control program.

### DESCRIPTION OF EMBODIMENTS

There is a case in which, when a distribution server transmits a file to each reception server at a distribution time, it takes a time to perform transmission, depending on line quality of a network or the size of the file and reception of the file at a reception server is delayed from the distribution time by several ten seconds or more. To cope with this, it is an option to reduce a delay in distribution by transmitting an encrypted file to each reception server in advance and distributing a decryption key at a timing at which a distribution time has arrived. However, for decryption processing for the encrypted file, a processing time differs depending on performance of the reception server. Therefore, there is a case in which, between reception servers, a difference by about several seconds occurs at a time when browsing of information stored in the file is enabled.

With reference to the drawings, embodiments of a distribution control program, a distribution control method, and an information processing device which are disclosed herein will be described in detail below. Note that a technology disclosed herein is not limited to the embodiments. Also, each of the embodiments below may be combined, as appropriate, to the extent that there is no contradiction.

### EMBODIMENTS

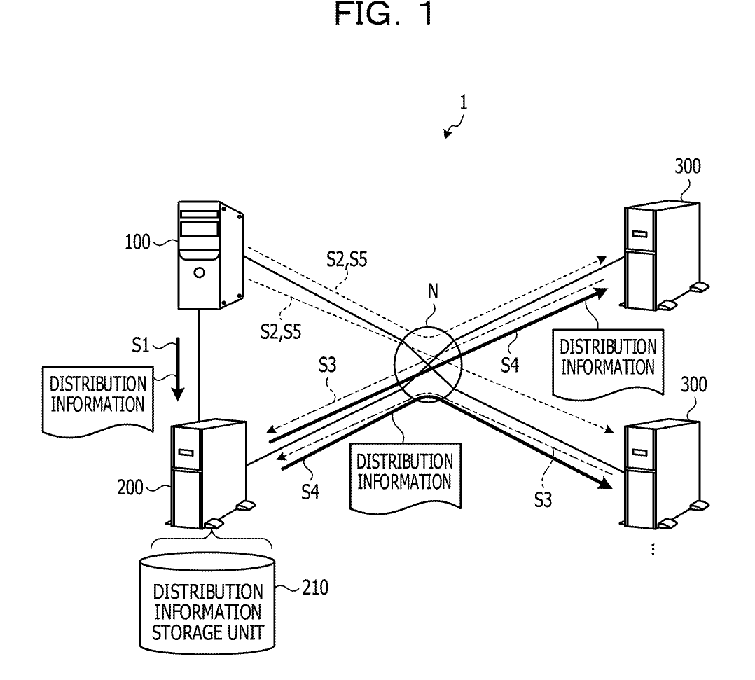

FIG. 1 is a diagram illustrating an example of a configuration of a distribution control system of an embodiment. A distribution control system 1 includes a distribution server 100, an external connection server 200, and a plurality of reception servers 300. Note that the number of the reception servers 300 is not limited and the distribution control system 1 may include an arbitrary number of the reception servers 300. The distribution server 100, the external connection server 200, and the plurality of reception servers 300 are coupled to one another via a network N to be mutually communicable. Note that the distribution server 100 may be configured to enable a communication to the network N and block a communication from the network N. For the network N, regardless of wired or wireless, a communication network of an arbitrary type, such as the Internet, a local area network (LAN), a virtual private network (VPN), or the like may be employed. Also, the distribution server 100 and the external connection server 200 are coupled to one another via an internal network, such as, for example, an intranet or the like, to be mutually communicable.

The distribution server 100 is an information processing device that is used for distributing disclosure information to the plurality of reception servers 300. The distribution server 100 acquires disclosure information from a database that is not illustrated. The disclosure information includes a disclosure material, such as a document file or the like, and material information, such as a publisher, a publication date, a publication time, various codes, a file type, a file size, or the like, of the disclosure material. The distribution server 100 distributes, to each of the reception servers 300 that are a plurality of information processing devices, distribution information that is data which the reception server 300 causes a storage area which is included in the reception server 300 and for which a setting for restricting browsing has been done to store. Note that the distribution information is information including one or more of the disclosure material and index information generated based on the material information of the disclosure material, and is distributed, for example, as a file. The distribution server 100 simultaneously distributes an instruction for switching to a setting of allowing browsing for the corresponding storage areas for which the setting for restricting browsing has been done to the plurality of reception servers 300 in accordance with detection of arrival of a certain time. Thus, the distribution server 100 is able to distribute data to the plurality of reception servers 300 at the same time.

The external connection server 200 is an information processing device that is used for relaying distribution information between the distribution server 100 and each of the reception servers 300. That is, the external connection server 200 improves security by prohibiting an access to the distribution server 100 from each of the reception servers 300. The external connection server 200 includes a distribution information storage unit 210 that stores distribution information. The external connection server 200 stores distribution information that has been received from the distribution server 100 in the distribution information storage unit 210. When the external connection server 200 accepts, via the network N, a coupling from each of the reception servers 300 for acquiring the distribution information to receive an acquisition request, the external connection server 200 transmits the distribution information stored in the distribution information storage unit 210 to the reception server 300 that is coupled thereto via the network N.

Note that, for a communication between the distribution server 100 and each of the external connection server 200 and the reception servers 300, encryption is performed, for example, using secure sockets layer/transport layer security (SSL/TLS), secure shell (SSH), or the like. Also, for a communication to the external connection server 200 from the distribution server 100 and the reception servers 300, for example, File Transfer Protocol (FTP) may be used. In this case, as FTP, for example, File Transfer Protocol over SSL/TLS (FTPS) or SSH File Transfer Protocol (SFTP) may be used.

The reception servers 300 are information processing devices that are placed, for example, at a user side of an information distribution service and are used for receiving distribution information that has been distributed by the distribution server 100 and providing information to users. When each of the reception servers 300 receives an acquisition order from the distribution server 100, the reception server 300 couples to the external connection server 200 to acquire the distribution information from the external connection server 200. The reception server 300 stores the distribution information that has been acquired in a non-disclosure folder. Also, when the reception server 300 receives a disclosure order from the distribution server 100, the reception server 300 provides the distribution information to the user by changing an access right of the non-disclosure folder to a disclosure folder. Note that the reception server 300 may be virtualized and may be caused to serve as a virtual server that operates on a physical server.

A flow of distribution control processing will be described below using FIG. 1. First, when the distribution server 100 acquires disclosure information from a database which is not illustrated, the distribution server 100 transmits distribution information including the disclosure material of the disclosure information to the external connection server 200 (Step S1). The external connection server 200 stores the distribution information that has been received in the distribution information storage unit 210. The distribution server 100 transmits an acquisition order to each of the reception servers 300 via the network N (Step S2).

When each of the reception servers 300 receives the acquisition order, a coupling with the external connection server 200 is established and transmits an acquisition request for the distribution information in accordance with the acquisition order (Step S3). When the external connection server 200 accepts the coupling to receive the acquisition request, the external connection server 200 transmits the distribution information in accordance with the acquisition request to the reception servers 300 that are being coupled thereto (Step S4). When the reception server 300 receives the distribution information, the reception server 300 stores the distribution information in a non-disclosure folder. Thereafter, when a distribution time arrives, the distribution server 100 transmits a disclosure order to each of the reception servers 300 (Step S5). When each of the reception servers 300 receives the disclosure order, the reception server 300 changes an access right of the non-disclosure folder to a disclosure folder. Thus, the user of each of the reception servers 300 is able to access a folder in which the distribution information is stored. That is, at a timing at which the reception server 300 receives the disclosure order and changes the access right, an access to the distribution information by the user is enabled, and therefore, the distribution server 100 is able to distribute the distribution information to the plurality of reception servers 300 at the same time.

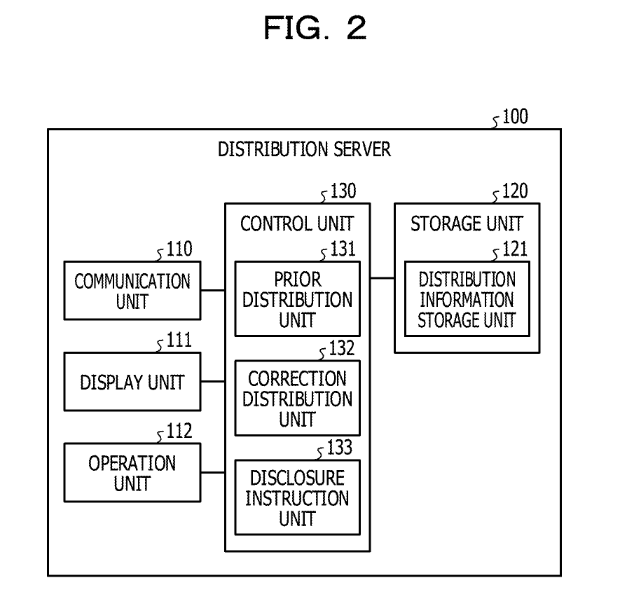

Next, a configuration of the distribution server 100 will be described. FIG. 2 is a block diagram illustrating an example of a configuration of a distribution server of an embodiment. As illustrated in FIG. 2, the distribution server 100 includes a communication unit 110, a display unit 111, an operation unit 112, a storage unit 120, and a control unit 130. Note that the distribution server 100 may be configured to include, in addition to the function units illustrated in FIG. 2, various types of function units, that is, for example, function units, such as, for example, various types of input devices, voice output devices, or the like, which are included in a known computer.

The communication unit 110 is realized, for example, by a Network Interface Card (NIC) or the like. The communication unit 110 is a communication interface which is wiredly or wirelessly coupled to the external connection server 200 and performs a communication of information with the external connection server 200. Also, the communication unit 110 is a communication interface which is wiredly or wirelessly coupled to each of the reception servers 300 via the network N and performs a communication of information with each of the reception servers 300. The communication unit 110 transmits the distribution information that has been input from the control unit 130 to the external connection server 200. Also, the communication unit 110 transmits the acquisition order and the disclosure order that have been input from the control unit 130 to each of the reception servers 300.

The display unit 111 is a display device that is used for displaying various types of information to an administrator of the distribution server 100. The display unit 111 is realized, for example, as a display device by a liquid crystal display or the like. The display unit 111 displays various types of screens, such as a display screen or the like, which have been input from the control unit 130.

The operation unit 112 is an input device that receives various types of operations from the administrator of the distribution server 100. The operation unit 112 is realized, for example, as an input device by a keyboard, a mouse, or the like. The operation unit 112 outputs, as operation information, an operation that has been input by the administrator to the control unit 130. Note that the operation unit 112 may be realized as an input device by a touch panel or the like and the display device of the display unit 111 and the input device of the operation unit 112 may be integrated.

The storage unit 120 is realized, for example, by a semiconductor memory element, such as a random access memory (RAM), a flash memory, or the like, or a storage device, such as a hard disk, an optical disk, or the like. The storage unit 120 includes a distribution information storage unit 121. Also, the storage unit 120 stores information that is used for processing in the control unit 130.

The distribution information storage unit 121 stores the distribution information based on the disclosure information that has been acquired from a database that is not illustrated. That is, the distribution information storage unit 121 stores, as distribution information, information including one or more of a disclosure material of the disclosure information and index information generated based on material information, such as a distribution date and time or the like of the disclosure material.

A program stored in an internal storage device is executed by a central processing unit (CPU), a micro processing unit (MPU) or the like, using RAM as a work area, and thereby the control unit 130 is realized. Also, the control unit 130 may be realized, for example, by an integrated circuit, such as, for example, an application specific integrated circuit (ASIC), a field programmable gate array (FPGA), or the like. The control unit 130 includes a prior distribution unit 131, a correction distribution unit 132, and a disclosure instruction unit 133 and realizes or executes a function or an operation of information processing which will be described blow. Note that an internal configuration of the control unit 130 is not limited to the configuration illustrated in FIG. 2 and may be some other configuration as long as the configuration is a configuration that performs information processing which will be described below.

The prior distribution unit 131 distributes the distribution information to each of the reception servers 300 in advance before a distribution time, that is, a disclosure time. The prior distribution unit 131 acquires disclosure information from a database which is not illustrated. The prior distribution unit 131 acquires, for example, each time a distribution request is accepted and disclosure information is registered in the database, the disclosure information from the database. The prior distribution unit 131 stores, as the distribution information, the disclosure material of the disclosure information that has been acquired in the distribution information storage unit 121.

The prior distribution unit 131 refers to the distribution information storage unit 121 and transmits the distribution information including the disclosure material to the external connection server 200 via the communication unit 110. That is, each time a distribution request is accepted and disclosure information is registered in the database, the prior distribution unit 131 transmits the distribution information including the disclosure material to the external connection server 200. Note that the prior distribution unit 131 couples to the external connection server 200 via the communication unit 110 using FTP, FTPS, or SFTP, and transmits the distribution information to the external connection server 200. When transmission of the distribution information to the external connection server 200 is completed, the prior distribution unit 131 transmits an acquisition order to each of the reception servers 300 via the communication unit 110 and the network N. Also, when the prior distribution unit 131 transmits the acquisition order, the prior distribution unit 131 outputs distribution completion information to the correction distribution unit 132.

In other words, the prior distribution unit 131 distributes, to each of the reception servers 300 that are a plurality of information processing devices, data which the reception server 300 causes the storage area which is included in the reception server 300 and for which a setting for restricting browsing has been done to store. Note that the setting for restricting browsing is, for example, a setting of an access right of a folder in which distribution information of the reception servers 300 is stored and a setting in which a browsing right is not given to a specific attribute, that is, for example, the user of the reception server 300.

When the distribution completion information is input from the prior distribution unit 131, the correction distribution unit 132 monitors the database which is not illustrated and determines whether or not there is a correction in the disclosure information. If there is a correction in the disclosure information, the correction distribution unit 132 acquires corrected disclosure information from the database. The correction distribution unit 132 generates index information, based on material information of the corrected disclosure information. The correction distribution unit 132 stores a disclosure material of the corrected disclosure information and the generated index information in the distribution information storage unit 121. Note that the index information may be configured to include respective disclosure times in a plurality of disclosure information.

The correction distribution unit 132 refers to the distribution information storage unit 121 and transmits the distribution information including the disclosure material and the index information to the external connection server 200 via the communication unit 110. Note that, similar to the prior distribution unit 131, the correction distribution unit 132 couples to the external connection server 200 using FTP, FTPS, or SFTP, and transmits the corrected distribution information to the external connection server 200. When transmission of the corrected distribution information to the external connection server 200 is completed, the correction distribution unit 132 transmits an acquisition order to each of the reception servers 300.

If there is not a correction in the disclosure information, or if the correction distribution unit 132 has transmitted an acquisition order, the correction distribution unit 132 determines whether or not a time earlier than the disclosure time by a certain time has arrived. Note that the certain time may be, for example, two minutes. If the correction distribution unit 132 has determined that the time earlier than the disclosure time by the certain time has not arrived, the correction distribution unit 132 continuously monitors whether or not there is a correction in the public information. If the correction distribution unit 132 has determined that the time earlier than the disclosure time by the certain time has arrived, the correction distribution unit 132 determines whether or not the distribution information including the index information has been transmitted.

If the correction distribution unit 132 has determined that the distribution information including the index information has not been transmitted, the correction distribution unit 132 generates index information, based on the material information of the disclosure information that has been acquired. The correction distribution unit 132 stores the generated index information in the distribution information storage unit 121. The correction distribution unit 132 refers to the distribution information storage unit 121 and transmits the distribution information including the index information to the external connection server 200 via the communication unit 110. Note that, similar to a case of the corrected distribution information, the correction distribution unit 132 couples to the external connection server 200 via the communication unit 110 using FTP, FTPS, or SFTP and transmits the distribution information including the index information to the external connection server 200.

When transmission of the distribution information including the index information to the external connection server 200 is completed, the correction distribution unit 132 transmits an acquisition order to each of the reception servers 300 via the communication unit 110 and the network N. After the correction distribution unit 132 transmits the acquisition order that corresponds to transmission of the distribution information including the index information, or if the correction distribution unit 132 has determined that the distribution information including the index information has been transmitted, the correction distribution unit 132 outputs preparation completion information to the disclosure instruction unit 133.

In other words, the correction distribution unit 132 distributes the index information in which data and a certain time that corresponds to the data are associated with one another. Note that the certain time is a disclosure time. Also, when the correction distribution unit 132 accepts correction of data, the correction distribution unit 132 distributes correction data which a storage area for which a setting for restricting browsing has been done is caused to store. Furthermore, when the correction distribution unit 132 detects arrival of a time earlier than the certain time by a first certain time, the correction distribution unit 132 reduces distribution of the correction data. Note that the first certain time may be, for example, two minutes. Also, the prior distribution unit 131 and the correction distribution unit 132 are examples of a first distribution unit.

When the disclosure time has arrived, the disclosure instruction unit 133 transmits a disclosure order to each of the reception servers 300. That is, the disclosure instruction unit 133 transmits the disclosure order to each of the reception servers 300, based on the disclosure time determined using a time of the distribution server 100 as a reference. When the preparation completion information is input from the correction distribution unit 132, the disclosure instruction unit 133 determines whether the disclosure time has arrived. If the disclosure instruction unit 133 has determined that the disclosure time has not arrived yet, the disclosure instruction unit 133 continuously repeats determination on whether or not the disclosure time has arrived. If the disclosure instruction unit 133 has determined that the disclosure time has arrived, the disclosure instruction unit 133 transmits a disclosure order to each of the reception servers 300 via the communication unit 110 and the network N.

In other words, the disclosure instruction unit 133 simultaneously distributes an instruction for switching to a setting of allowing browsing for the corresponding storage area for which the setting for restricting browsing has been done to the plurality of reception servers 300 that are a plurality of information processing devices in accordance with detection of arrival of a certain time. Note that the setting for restricting browsing is, for example, a setting of an access right of a folder in which distribution information of the reception servers 300 is stored and a setting in which a browsing right is given to a specific attribute, that is, for example, the users of the reception servers 300. Also, the disclosure instruction unit 133 is an example of a second distribution unit.

That is, the setting for restricting browsing and the setting of allowing browsing are performed by changing a reference right of the access right for the folder which is the storage area of the corresponding reception server 300 and in which the distribution information is stored. Note that the access right of the folder is a permission of the folder. Also, changing a reference right is, for example, changing, if browsing is allowed, the permission such that the user of the reception server 300 is permitted to read the folder and changing, if browsing is restricted, the permission such that the user is not permitted to read the folder.

Also, the disclosure instruction unit 133 may be configured to transmit, when next distribution information is distributed, for the folder in which the distribution information for which the disclosure order has been once transmitted is stored, a non-disclosure order of changing the access right to a non-disclosure folder again. For example, if it is scheduled to distribute the next distribution information at a next certain time which is ten days after a first distribution of the distribution information, the disclosure instruction unit 133 transmits a non-disclosure order of changing the access right to a non-disclosure folder at a time earlier than the next certain time by a second certain time, that is, for example, 24 hours. Thus, also, at the time of distribution of the next distribution information, the distribution server 100 is able to distribute the distribution information to the plurality of reception servers 300 at the same time using the same folder.

In other words, after arrival of the certain time is detected, when the disclosure instruction unit 133 detects arrival of the time earlier than the next certain time by the second certain time, the disclosure instruction unit 133 simultaneously distributes an instruction for switching to the setting of restricting browsing for the storage area the setting of which has been switched to the setting of allowing browsing.

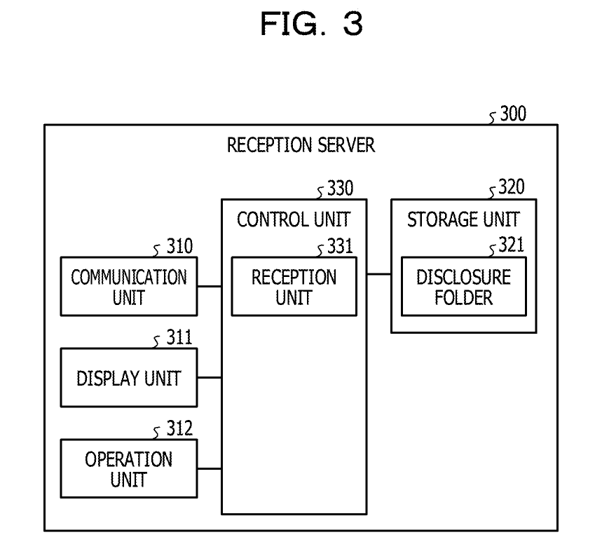

Subsequently, a configuration of the reception server 300 will be described. FIG. 3 is a block diagram illustrating an example of a configuration of a reception server of an embodiment. As illustrated in FIG. 3, the reception server 300 includes a communication unit 310, a display unit 311, an operation unit 312, a storage unit 320, and a control unit 330. Note that the reception server 300 may be configured to include, in addition to the function units illustrated in FIG. 3, various types of function units, that is, for example, function units, such as, for example, various types of input devices, voice output devices, or the like, which are included in a known computer.

The communication unit 310 is realized, for example, by NIC or the like. The communication unit 310 is a communication interface that is wiredly or wirelessly coupled to the distribution server 100 and the external connection server 200 via the network N and performs a communication of information with the distribution server 100 and the external connection server 200. The communication unit 310 transmits a coupling request and an acquisition request that have been input from the control unit 330 to the external connection server 200. Also, the communication unit 310 outputs an acquisition order and a disclosure order that have been received from the distribution server 100 and distribution information that has been received from the external connection server 200 to the control unit 330.

The display unit 311 is a display device that is used for displaying various types of information to users of the reception servers 300. The display unit 311 is realized, for example, as a display device by a liquid crystal display or the like. The display unit 311 displays various types of screens, such as a display screen or the like, which have been input from the control unit 330.

The operation unit 312 is an input device that accepts various types of operations from the users of the reception servers 300. The operation unit 312 is realized, for example, as an input device by a keyboard, a mouse, or the like. The operation unit 312 outputs, as operation information, an operation that has been input by the user to the control unit 330. Note that the operation unit 312 may be realized as an input device by a touch panel or the like and the display device of the display unit 311 and the input device of the operation unit 312 may be integrated. Also, the display unit 311 and the operation unit 312 may be configured such that a remote access thereto is made using a terminal device which is not illustrated.

The storage unit 320 is realized, for example, by a semiconductor memory element, such as RAM, a flash memory, or the like, or a storage device, such as a hard disk, an optical disk, or the like. The storage unit 320 includes a disclosure folder 321. Also, the storage unit 320 stores information that is used for processing in the control unit 330.

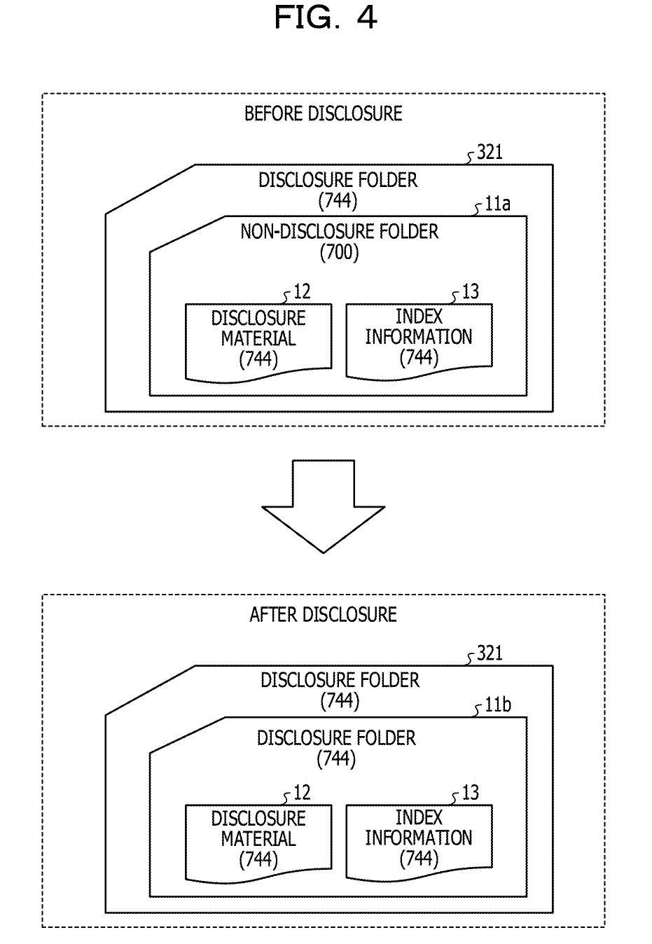

The disclosure folder 321 is, for example, a folder, that is, a storage area, which is accessible when the user of the corresponding reception server 300 accesses there from a terminal device which is not illustrated. FIG. 4 is a diagram illustrating an example of a disclosure folder. As illustrated in FIG. 4, the disclosure folder 321 includes a non-disclosure folder 11a before a disclosure order is received, that is, before disclosure. In the non-disclosure folder 11a, a disclosure material 12 that is distribution information and index information 13 are stored. In this case, as for access rights, that is, permissions, of each folder and file, the permission of the disclosure folder 321 is “744”, the permission of the non-disclosure folder 11a is “700”, the permission of the disclosure material 12 is “744”, and the permission of the index information 13 is “744”. Note that each permission is represented by three octal digits.

In this case, a permission will be described. A permission is allowance information for an access, such as read, write, or the like, which has been defined for each folder, that is, each directory or each file. The octal digits of a permission correspond to a user class, a group class, and some other class from the left, and each digit indicates allowance of read, write, and execution for the corresponding class. When “4” is added to each digit, read is permitted, when “2” is added to each digit, write is permitted, and “1” is added to each digit, execution is permitted.

For example, when a permission of a file is “744”, a user who owns the file is permitted to perform read, write, and execution of the file. In contrast, other users of a group to which the user belongs or other users are permitted to perform read for the file but not permitted to perform write and execution of the file. Also, when a permission of a file is “700”, a user who owns the file is permitted to perform read, write, and execution of the file. In contrast, other users of a group to which the user belongs or other users are not permitted to perform read, write, and execution of the file at all.

Also, as another notation for a permission, a symbol notation may be used. In this case, a permission is represented by a character string of ten characters. In the symbol notation, a first character indicates a file type, subsequent three characters for each class indicate respective permissions of an owner, other users of the group, and other users. For example, “-rwxr-xr-x” indicates a normal file and the owner is permitted to perform read, write, and execution of the file. In contrast, the other users of the group and the other users are permitted to perform read and execution of the file but are not permitted to perform write of the file.

In the example of FIG. 4, as for the non-disclosure folder 11a before disclosure, the permission thereof is “700”, and therefore, an administrator of the distribution server 100, who is an owner of the non-disclosure folder 11a, is permitted to perform read, write, and execution. In contrast, the users of the reception servers 300 are not the owner of the non-disclosure folder 11a, and therefore, are not permitted to perform read, write, and execution. That is, the users of the reception servers 300 are in a state in which browsing of the disclosure material 12 and the index information 13 which are stored in the non-disclosure folder 11a by the users of the reception servers 300 is restricted.

Next, when the reception server 300 receives a disclosure order from the distribution server 100, the non-disclosure folder 11a before disclosure becomes a disclosure folder 11b after disclosure. That is, the non-disclosure folder 11a and the disclosure folder 11b are the same folder, although permissions therefor are different from one another. Note that, in the following description, as a folder which stores distribution information, each of the non-disclosure folder 11a and the disclosure folder 11b is referred to as a folder 11, when the non-disclosure folder 11a and the disclosure folder 11b are not distinguished from one another. As for the disclosure folder 11b, the permission thereof is “744”, and therefore, the user of the reception server 300 is permitted to perform read. That is, the user of the reception server 300 is in a state in which the user is permitted to browse the disclosure material 12 and the index information 13 stored in the disclosure folder 11b.

Return to the description of FIG. 3. A program stored in an internal storage device is executed, for example, by CPU, MPU, or the like, using RAM as a work area, and thereby, the control unit 330 is realized. Also, the control unit 330 may be realized, for example, by an integrated circuit, such as ASIC, FPGA, or the like. Furthermore, the control unit 330 may be realized as a virtual server together with the storage unit 320.

The control unit 330 includes a reception unit 331 and realizes or executes a function or an operation of information processing which will be described blow. Note that an internal configuration of the control unit 330 is not limited to the configuration illustrated in FIG. 3 and may be some other configuration as long as the configuration is a configuration that performs information processing which will be described below.

The reception unit 331 acquires distribution information from the external connection server 200 in accordance with an acquisition order that has been received from the distribution server 100 and also changes, when the reception unit 331 receives a disclosure order, an access right of a folder in which the distribution information is stored from the non-disclosure folder 11a to the disclosure folder 11b. The reception unit 331 receives the acquisition order from the distribution server 100 via the network N and the communication unit 310. The reception unit 331 transmits a coupling request to the external connection server 200 in accordance with the received acquisition order via the communication unit 310 and the network N to establish a coupling with the external connection server 200. When the reception unit 331 is coupled to the external connection server 200, the reception unit 331 transmits an acquisition request to the external connection server 200 and acquires the distribution information from the external connection server 200 via the network N and the communication unit 310. The reception unit 331 stores the acquired distribution information in the non-disclosure folder 11a in the disclosure folder 321.

The reception unit 331 receives a disclosure order from the distribution server 100 via the network N and the communication unit 310. When the reception unit 331 receives the disclosure order, the reception unit 331 changes the access right of the non-disclosure folder 11a to the disclosure folder 11b. That is, the reception unit 331 changes a permission of the folder 11 such that the user of the reception server 300 is able to read the disclosure material 12 and the index information 13 in the disclosure folder 11b.

Access rights of the reception servers 300 will be described below. For example, each of the reception servers 300 is constructed as a virtual server in a physical server owned by the corresponding user. Note that, for virtualization of the reception servers 300, for example, a kernel-based virtual machine (KVM), QEMU, Xen, or the like may be used. The administrator of the distribution server 100 distributes an image of the corresponding reception server 300 to the user that receives an information distribution service and has the user to install it in the physical server.

For the virtualized reception servers 300, an account of a super user who has an administrative right is the administrator of the distribution server 100. That is, for example, when the reception server 300 is constructed by Linux (a registered trademark), the administrator of the distribution server 100 has a root right of the reception server 300. That is, the reception unit 331 of the reception server 300 is an application that operates under the administrative right. Also, the user of the reception server 300 accesses the reception server 300 using a normal account. Thus, in the reception server 300, the administrator of the distribution server 100 changes the access right of the folder in which the distribution information is stored, and thereby, an access to the folder in which the distribution information is stored by the user of the reception server 300 may be controlled. That is, in the reception server 300, the administrator of the distribution server 100 has the root right of the reception server 300 and the user of the reception server 300 is not promoted to have the root right, so that it is possible to prohibit the user of the reception server 300 to browse distribution information before a disclosure time.

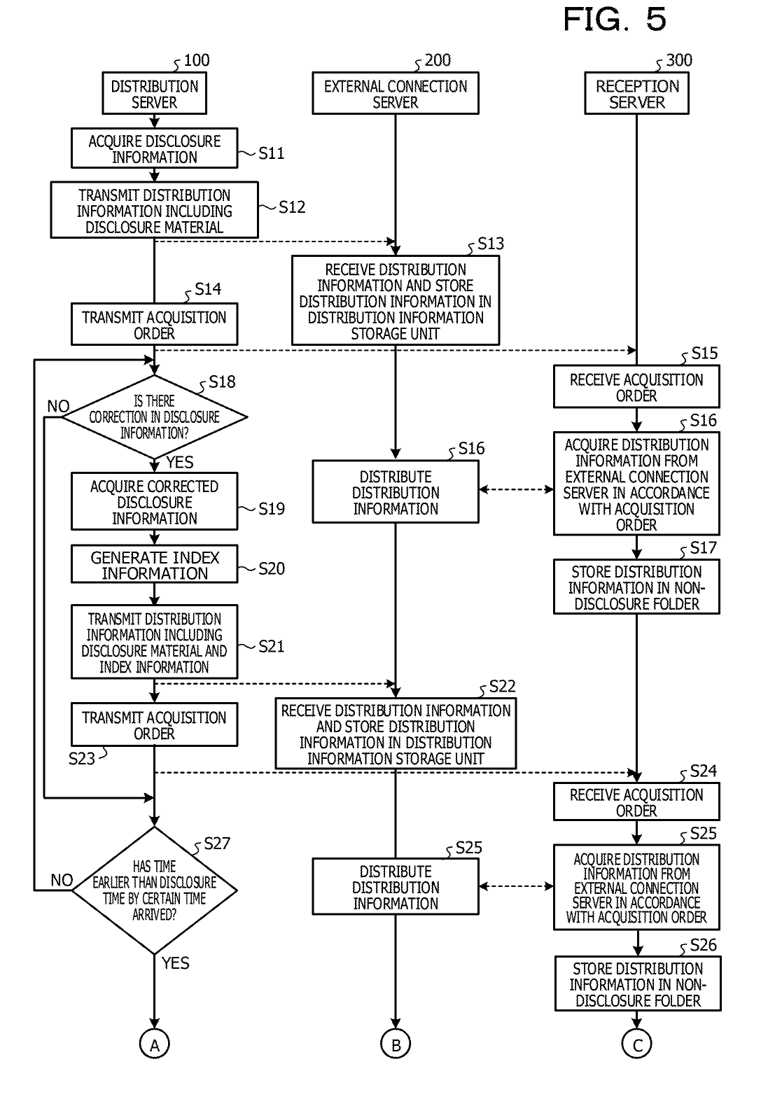

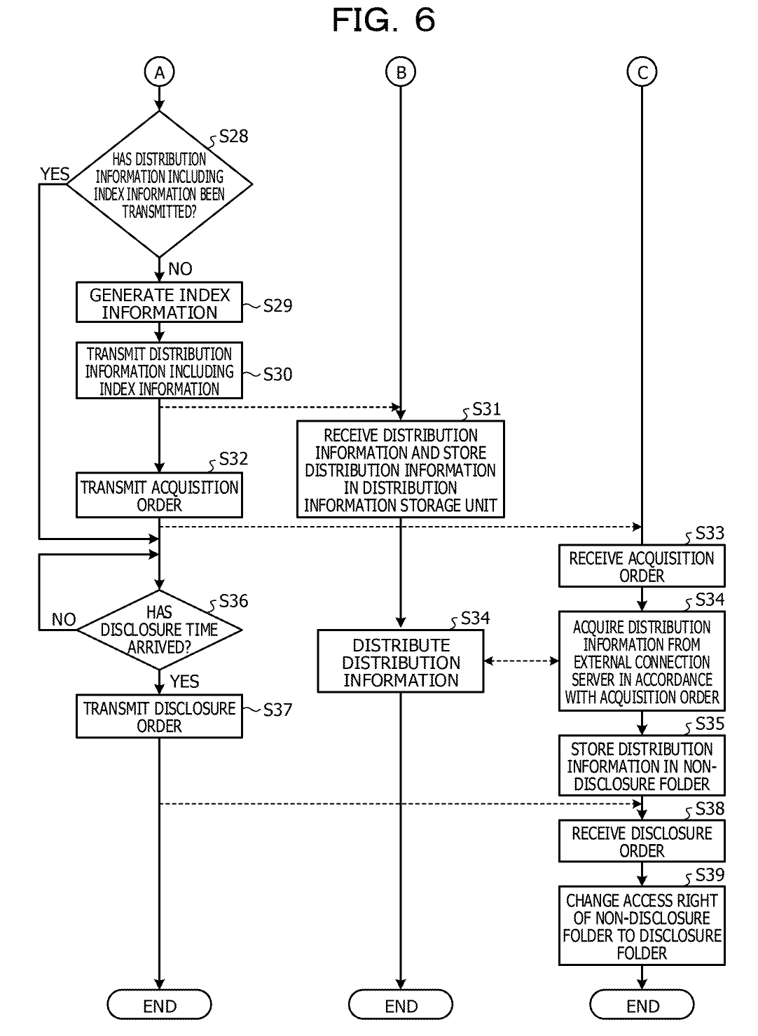

Next, an operation of the distribution control system 1 of an embodiment will be described. FIG. 5 and FIG. 6 are sequence diagrams illustrating an example of distribution control processing of an embodiment.

The prior distribution unit 131 of the distribution server 100 acquires disclosure information from a database which is not illustrated (Step S11). The prior distribution unit 131 stores, as distribution information, the disclosure material 12 of the acquired disclosure information in the distribution information storage unit 121. The prior distribution unit 131 refers to the distribution information storage unit 121 and transmits the distribution information including the disclosure material 12 to the external connection server 200 (Step S12).

The external connection server 200 receives the distribution information from the distribution server 100 and stores the received distribution information in the distribution information storage unit 210 (Step S13).

When transmission of the distribution information to the external connection server 200 is completed, the prior distribution unit 131 of the distribution server 100 transmits an acquisition order to each of the reception servers 300 (Step S14). Also, when the prior distribution unit 131 transmits the acquisition order, the prior distribution unit 131 outputs distribution completion information to the correction distribution unit 132.

The reception unit 331 of the reception server 300 receives the acquisition order from the distribution server 100 (Step S15). The reception unit 331 transmits a coupling request to the external connection server 200 in accordance with the received acquisition order to establish a coupling with the external connection server 200. When the reception unit 331 is coupled to the external connection server 200, the reception unit 331 transmits an acquisition request to the external connection server 200.

When the external connection server 200 accepts a coupling from each of the reception servers 300 and receives the acquisition request, the external connection server 200 distributes the distribution information stored in the distribution information storage unit 210 to the reception server 300 that is coupled thereto.

The reception unit 331 of the reception server 300 acquires the distribution information from the external connection server 200 (Step S16). The reception unit 331 stores the acquired distribution information in the non-disclosure folder 11a in the disclosure folder 321 (Step S17).

When the distribution completion information is input from the prior distribution unit 131, the correction distribution unit 132 of the distribution server 100 monitors the database which is not illustrated and determines whether or not there is a correction in the disclosure information (Step S18). If there is not a correction in the disclosure information (No in Step S18), the correction distribution unit 132 causes the process to proceed to Step S27.

If there is a correction in the disclosure information (Yes in Step S18), the correction distribution unit 132 acquires the corrected disclosure information from the database (Step S19). The correction distribution unit 132 generates the index information 13, based on material information of the corrected disclosure information (Step S20). The correction distribution unit 132 stores the disclosure material 12 of the corrected disclosure information and the generated index information 13 in the distribution information storage unit 121. The correction distribution unit 132 refers to the distribution information storage unit 121 and transmits the distribution information including the disclosure material 12 and the index information 13 to the external connection server 200 (Step S21).

The external connection server 200 receives the distribution information from the distribution server 100 and stores the received distribution information in the distribution information storage unit 210 (Step S22).

When transmission of the distribution information to the external connection server 200 is completed, the correction distribution unit 132 of the distribution server 100 transmits an acquisition order to each of the reception servers 300 (Step S23).

The reception unit 331 of the reception server 300 receives the acquisition order from the distribution server 100 (Step S24). The reception unit 331 transmits a coupling request to the external connection server 200 in accordance with the received acquisition order to establish a coupling with the external connection server 200. When the reception unit 331 is coupled to the external connection server 200, the reception unit 331 transmits an acquisition request to the external connection server 200.

When the external connection server 200 accepts a coupling from each of the reception servers 300 and receives the acquisition request, the external connection server 200 distributes the distribution information stored in the distribution information storage unit 210 to the reception server 300 that is coupled thereto.

The reception unit 331 of the reception server 300 acquires the distribution information from the external connection server 200 (Step S25). The reception unit 331 stores the acquired distribution information in the non-disclosure folder 11a in the disclosure folder 321 (Step S26).

The correction distribution unit 132 of the distribution server 100 determines, if there is not a correction in the disclosure information (No in Step S18) or if the correction distribution unit 132 has transmitted an acquisition order (Step S23), whether or not a time earlier than a disclosure time by a certain time has arrived (Step S27). If the correction distribution unit 132 has determined that the time earlier than the disclosure time by the certain time has not arrived (No in Step S27), the correction distribution unit 132 causes the process to return to Step S18. If the correction distribution unit 132 has determined that the time earlier than the disclosure time by the certain time has arrived (Yes in Step S27), the correction distribution unit 132 determines whether or not the distribution information including the index information 13 has been transmitted (Step S28). If the correction distribution unit 132 has determined that the distribution information including the index information 13 has been transmitted (Yes in Step S28), the correction distribution unit 132 causes the process to proceed to Step S36.

If the correction distribution unit 132 has determined that the distribution information including the index information 13 has not been transmitted (No in Step S28), the correction distribution unit 132 generates the index information 13, based on material information of the acquired disclosure information (Step S29). The correction distribution unit 132 stores the generated index information 13 in the distribution information storage unit 121. The correction distribution unit 132 refers to the distribution information storage unit 121 and transmits the distribution information including the index information 13 to the external connection server 200 (Step S30).

The external connection server 200 receives the distribution information from the distribution server 100 and stores the received distribution information in the distribution information storage unit 210 (Step S31).

When transmission of the distribution information including the index information 13 to the external connection server 200 is completed, the correction distribution unit 132 of the distribution server 100 transmits an acquisition order to each of the reception servers 300 (Step S32).

The reception unit 331 of the reception server 300 receives the acquisition order from the distribution server 100 (Step S33). The reception unit 331 transmits a coupling request to the external connection server 200 in accordance with the received acquisition order to establish a coupling with the external connection server 200. When the reception unit 331 is coupled to the external connection server 200, the reception unit 331 transmits an acquisition request to the external connection server 200.

When the external connection server 200 accepts a coupling from each of the reception servers 300 and receives the acquisition request, the external connection server 200 distributes the distribution information stored in the distribution information storage unit 210 to the reception server 300 that is coupled thereto.

The reception unit 331 of the reception server 300 acquires the distribution information from the external connection server 200 (Step S34). The reception unit 331 stores the acquired distribution information in the non-disclosure folder 11a in the disclosure folder 321 (Step S35).

After the correction distribution unit 132 of the distribution server 100 transmits an acquisition order in Step S32, or if the correction distribution unit 132 has determined that the distribution information including the index information 13 has been transmitted (Yes in Step S28), the correction distribution unit 132 of the distribution server 100 outputs preparation completion information to the disclosure instruction unit 133.

When the preparation completion information is input from the correction distribution unit 132, the disclosure instruction unit 133 determines whether or not a disclosure time has arrived (Step S36). If the disclosure instruction unit 133 has determined that the disclosure time has not arrived yet (No in Step S36), the disclosure instruction unit 133 continuously repeats determination of Step S36. If the disclosure instruction unit 133 has determined that the disclosure time has arrived (Yes in Step S36), the disclosure instruction unit 133 transmits a disclosure order to each of the reception servers 300 (Step S37).

The reception unit 331 of the reception server 300 receives the disclosure order from the distribution server 100 (Step S38). When the reception unit 331 receives the disclosure order, the reception unit 331 changes an access right of the non-disclosure folder 11a to the disclosure folder 11b (Step S39). Thus, the distribution server 100 is able to distribute the distribution information to the plurality of reception servers 300 at the same time. That is, even when the number of the reception servers 300 is several hundreds, the distribution server 100 can perform distribution of information at the same time by an error of less than a second (millisecond order unit), that is, simultaneous distribution, to each of the reception servers 300. Also, in the distribution control system 1, an exclusive line is not used because a decryption key of an encrypted file is not transmitted, and therefore, an instruction cost of the user may be reduced. Also, in the distribution control system 1, even when a high performance server is not introduced at a user side, there is not a difference in disclosure time, and therefore, an inexpensive server or a virtual server constructed in an existing server may be used, thus reducing the introduction cost of the user.

As described above, the distribution server 100 distributes, to each of the plurality of the reception servers 300, data which the reception server 300 causes the folder 11 that is a storage area which is included in the reception server 300 and for which a setting for restricting browsing has been done to store. Also, for the corresponding folder 11 for which the setting of restricting browsing has been done, the distribution server 100 simultaneously distributes an instruction for switching to a setting of allowing browsing to the plurality of reception servers 300 in accordance with detection of arrival of a certain time. As a result, the distribution server 100 is able to distribute data to the plurality of reception servers 300 at the same time.

Also, in the distribution server 100, the setting of restricting browsing is a setting in which a browsing right is not given to a specific attribute and the setting of allowing browsing is a setting in which a browsing right is given to a specific attribute. As a result, the distribution server 100 is able to control a browsing right for distribution information for each of the users of the reception servers 300.

Also, the distribution server 100 distributes index information in which data and a certain time that corresponds to the data are associated with one another. As a result, the distribution server 100 is able to disclose, that is, distribute, the data at the certain time.

Also, when the distribution server 100 accepts a correction of data, the distribution server 100 distributes correction data for which the setting of restricting browsing has been done and which the folder 11 is caused to store. As a result, the distribution server 100 is able to correct the distribution information before disclosure.

Also, when the distribution server 100 detects arrival of the time earlier than the certain time by the first certain time, the distribution server 100 controls distribution of the correction data. As a result, the distribution server 100 is able to keep the disclosure time from arriving before the correction data is distributed to all of the reception servers 300.

Also, when the distribution server 100 detects, after the distribution server 100 has detected arrival of the certain time, arrival of the time earlier than the next certain time by the second certain time, the distribution server 100 simultaneously distributes, for the folder 11 the setting of which has been switched to the setting of allowing browsing, an instruction for switching to the setting of restricting browsing. As a result, also when next distribution information is distributed, the distribution server 100 can distribute the distribution information to the plurality of reception servers 300 at the same time using the same folder.

Also, in the distribution server 100, the setting of restricting browsing and the setting of allowing browsing are performed by changing the reference right of the folder 11. As a result, the distribution server 100 is able to distribute data to the plurality of reception servers 300 at the same time.

Note that, although, in the above-described embodiments, a case in which a virtual server is used as the reception server 300 has been described, but the present disclosure is not limited thereto. For example, a physical server may be used as the reception server 300.

Also, in the above-described embodiments, a target of change of an access right in the reception server 300 is the folder 11, but the present disclosure is not limited thereto. For example, a configuration in which, assuming that the folder 11 is the disclosure folder 11b, access rights of the disclosure material 12 and the index information 13 that are stored in the disclosure folder 11b are changed from non-disclosure to disclosure may be employed. Furthermore, a configuration in which access rights of the folder 11, the disclosure material 12, and the index information 13 are changed may be employed.

Also, although, in the above-described embodiments, each of the users of the reception servers 300 accesses the corresponding reception server 300 from a terminal device which is not illustrated to refer to the disclosure folder 321, the present disclosure is not limited thereto. For example, a configuration in which an access to the reception server 300 is made from another virtual server on the same physical server on which the virtual server of the reception server 300 operates may be employed.

Also, each component element of each unit illustrated in the drawings may not be physically configured as illustrated in the drawings. That is, specific embodiments of disintegration and integration of each unit are not limited to those illustrated in the drawings, and all or some of the units may be disintegrated/integrated functionally or physically in an arbitrary unit in accordance with various loads, use conditions, and the like. For example, the prior distribution unit 131 and the correction distribution unit 132 may be integrated to form the first distribution unit. Also, the order of the respective steps illustrated in the drawings is not limited to the above-described order and, to the extent that there is no contradiction, the respective steps may be simultaneously performed and also may be performed in a different order.

Furthermore, the whole or a part of each processing function performed by each unit may be executed on a CPU (or a microcomputer, such as an MPU, a micro controller unit (MCU), or the like). Needless to say, the whole or a part of each processing function may be executed on a program that is analyzed and executed by a CPU (or a microcomputer, such as an MPU, an MCU, or the like) or a hardware of a wired logic.

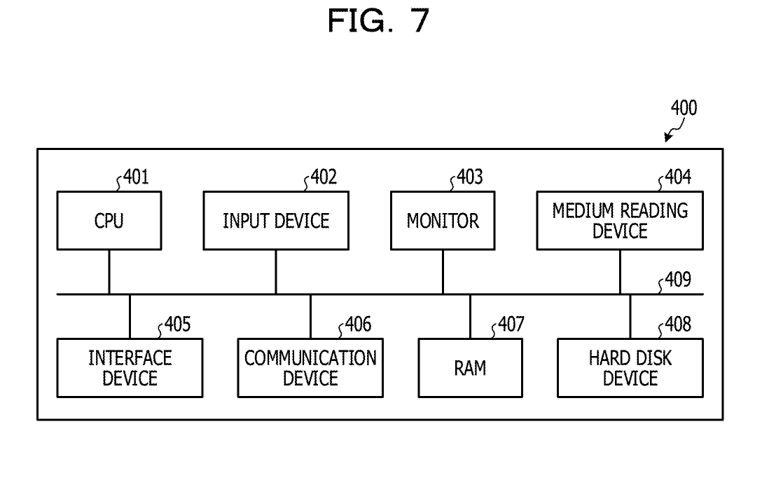

Incidentally, various types of processing described in the above-described embodiments may be realized by causing a computer to execute a program that has been prepared in advance. Therefore, an example of a computer that executes a program having similar functions to those described in the above-described embodiments will be described below. FIG. 7 is a diagram illustrating an example of a computer that executes a distribution control program.

As illustrated in FIG. 7, a computer 400 includes a CPU 401 that executes various types of arithmetic processing, an input device 402 that accepts data input, and a monitor 403. Also, the computer 400 includes a medium reading device 404 that reads a program or the like from a storage medium, an interface device 405 that provides a coupling to each of various units, and a communication device 406 that provides a wired or wireless coupling to another information processing device or the like. Also, the computer 400 also includes RAM 407 that temporarily stores various types of information and a hard disk device 408. Each of the units 401 to 408 is coupled to a bus 409.

A distribution control program having a similar function to that of each of the processing units of the prior distribution unit 131, the correction distribution unit 132, and the disclosure instruction unit 133 illustrated in FIG. 2 is stored in the hard disk device 408. Also, various types of data used for realizing the distribution information storage unit 121 and the distribution control program are stored in the hard disk device 408. The input device 402 accepts, for example, an input of various types of information, such as operation information or the like, from an administrator of the computer 400. The monitor 403 displays, for example, various types of screens, such as a display screen or the like, to the administrator of the computer 400. For example, a printing device or the like is coupled to the interface device 405. The communication device 406, for example, has a similar function to that of the communication unit 110 illustrated in FIG. 2, is coupled to the external connection server 200 and the network N, and exchanges various types of information with the external connection server 200 and each of the reception servers 300.

The CPU 401 reads each of programs stored in the hard disk device 408, expands the programs in the RAM 407, and then, executes the programs to thereby perform various types of processing. The programs are able to cause the computer 400 to function as the prior distribution unit 131, the correction distribution unit 132, and the disclosure instruction unit 133 illustrated in FIG. 2.

Note that there may be a case in which the above-described distribution control program is not stored in the hard disk device 408. For example, a configuration in which the computer 400 reads a program stored in a computer readable storage medium from which the computer 400 may read data and executes the program may be employed. For example, a portable recording medium, such as CD-ROM, a DVD disk, a universal serial bus (USB) memory, or the like, a semiconductor memory, such as a flash memory or the like, or a hard disk drive, or the like, corresponds to the computer readable storage medium from which the computer 400 may read data. As another option, a configuration in which the distribution control program is stored in a unit coupled to a public line, the Internet, LAN, or the like in advance and the computer 400 reads the distribution control program from the unit to execute the distribution control program may be employed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information transmission device configured to be coupled to a plurality of information receiving devices, each of which includes a storage area and executes a first processing of restricting disclosure of data held in the storage area, the information transmission device comprising:
a memory; and
a processor coupled to the memory and configured to
transmit first data to each of the plurality of information receiving devices, and
transmit, after transmitting the first data to each of the plurality of information receiving devices, a release instruction signal that instructs a second processing of releasing the first processing for the first data held in the storage area to each of the plurality of information receiving devices simultaneously.

2. The information transmission device according to claim 1,
wherein the first processing for the first data is prohibiting disclosure based on an attribute of a transmission source of an access request for the first data, and
the second processing for the first data is allowing disclosure based on the attribute.

3. The information transmission device according to claim 1,
wherein the processor is configured to
transmit index information that indicates a first time that corresponds to the first data to each of the plurality of information receiving devices, and
transmit the release instruction signal to each of the plurality of information receiving devices at the first time.

4. The information transmission device according to claim 1,
wherein the processor is configured to
after transmitting the first data to each of the plurality of information receiving devices and before transmitting the release instruction signal to each of the plurality of information receiving devices, receive a correction instruction signal that instructs correction of the first data, and
transmit corrected data of the first data to each of the information receiving devices based on the correction instruction signal.

5. The information transmission device according to claim 4,
wherein the processor is configured to stop transmission of the corrected data at a second time that is earlier than the first time.

6. The information transmission device according to claim 1,
wherein the processor is configured to transmit a restriction instruction signal that instructs restriction of disclosure for the first data held in the storage area to each of the plurality of information receiving devices simultaneously at a third time that is later than the first time.

7. The information transmission device according to claim 1,
wherein the first processing for the first data and the second processing for the first data are changing an access right of the storage area.

8. A method executed by an information transmission device and a plurality of information receiving devices each of which includes a storage area and executes a first processing of restricting disclosure of data held in the storage area, the method comprising:
transmitting, by the information transmission device, first data to each of the plurality of information receiving devices; and
transmitting, by the information transmission device, after transmitting the first data to each of the plurality of information receiving devices, a release instruction signal that instructs a second processing of releasing the first processing for the first data held in the storage area to each of the plurality of information receiving devices simultaneously; and
releasing, by each of the plurality of information receiving devices, the first processing for the first data held in the storage area to each of the plurality of information receiving devices.

9. The method according to claim 8,
wherein the first processing for the first data is prohibiting disclosure based on an attribute of a transmission source of an access request for the first data, and
the second processing for the first data is allowing disclosure based on the attribute.

10. The method according to claim 8 further comprising:
transmitting, by the information transmission device, index information that indicates a first time that corresponds to the first data to each of the plurality of information receiving devices, wherein
the information transmission device transmits the release instruction signal to each of the plurality of information receiving devices at the first time.

11. The method according to claim 8 further comprising:
after transmitting the first data to each of the plurality of information receiving devices and before transmitting the release instruction signal to each of the plurality of information receiving devices, receiving, by the information transmission device, a correction instruction signal that instructs correction of the first data; and
transmitting, by the information transmission device, corrected data of the first data to each of the information receiving devices based on the correction instruction signal.

12. The method according to claim 11 further comprising:
stopping, by the information transmission device, transmission of the corrected data at a second time that is earlier than the first time.

13. The method according to claim 8 further comprising:
transmitting, by the information transmission device, a restriction instruction signal that instructs restriction of disclosure for the first data held in the storage area to each of the plurality of information receiving devices simultaneously at a third time that is later than the first time.

14. The method according to claim 8,
wherein the first processing for the first data and the second processing for the first data are changing an access right of the storage area.

15. A non-transitory computer-readable storage medium storing a program that causes an information processing apparatus to execute a process, the information processing apparatus being coupled to a plurality of information receiving devices each of which includes a storage area and executes a first processing of restricting disclosure of data held in the storage area, the process comprising:
transmitting first data to each of the plurality of information receiving devices; and
transmitting, after transmitting the first data to each of the plurality of information receiving devices, a release instruction signal that instructs a second processing of releasing the first processing for the first data held in the storage area to each of the plurality of information receiving devices simultaneously.

16. The non-transitory computer-readable storage medium according to claim 15,
wherein the first processing for the first data is prohibiting disclosure based on an attribute of a transmission source of an access request for the first data, and
the second processing for the first data is allowing disclosure based on the attribute.

17. The non-transitory computer-readable storage medium according to claim 16, the process further comprising:
transmitting index information that indicates a first time that corresponds to the first data to each of the plurality of information receiving devices, wherein
the information transmission device transmits the release instruction signal to each of the plurality of information receiving devices at the first time.

18. The non-transitory computer-readable storage medium according to claim 15, the process further comprising:
after transmitting the first data to each of the plurality of information receiving devices and before transmitting the release instruction signal to each of the plurality of information receiving devices, receiving, by the information transmission device, a correction instruction signal that instructs correction of the first data; and
transmitting corrected data of the first data to each of the information receiving devices based on the correction instruction signal.

19. The non-transitory computer-readable storage medium according to claim 18, the process further comprising:
stopping transmission of the corrected data at a second time that is earlier than the first time.

20. The non-transitory computer-readable storage medium according to claim 15, the process further comprising:
transmitting a restriction instruction signal that instructs restriction of disclosure for the first data held in the storage area to each of the plurality of information receiving devices simultaneously at a third time that is later than the first time.
